(19) United States
(12) Patent Application Publication
(10) Pub. No.: US 2012/0162411 A1
(43) Pub. Date: Jun. 28, 2012

(54) METHOD AND APPARATUS FOR OPERATION OF MOVING OBJECT IN UNSTRUCTURED ENVIRONMENT

(75) Inventors: Min Su JANG, Daejeon (KR); Young-Jo CHO, Daejeon (KR); Hyeonsung CHO, Daejeon (KR); Cheonshu PARK, Daejeon (KR); Jae Hong KIM, Daejeon (KR); Joo Chan SOHN, Daejeon (KR)

(73) Assignee: Electronics and Telecommunications Research Institute, Daejeon (KR)

(21) Appl. No.: 13/335,829

(22) Filed: Dec. 22, 2011

(30) Foreign Application Priority Data
Dec. 23, 2010 (KR) 10-2010-0133404

(51) Int. Cl. H04N 7/18

(52) U.S. Cl. 348/135; 348/E07.085

(57) ABSTRACT

An apparatus for operation of a moving object in an unstructured environment includes a sensor unit configured to sense vibration of the moving object to produce a sensing signal; an image capturing unit configured to capture an image of a surrounding environment on which the moving object travels; a signal synchronization unit configured to synchronize the sensing signal from the sensor unit with the image captured by an image capturing unit through mapping therebetween; an amplitude extraction unit configured to extract a tilt of the moving object based on the sensing signal from the sensor unit and calculate a viewing angle and a moving distance of the moving object based on the calculated tilt; and an image correction unit configured to perform coordinate transformation on the captured image by using the viewing angle and the moving distance to generate a corrected image.

### CROSS-REFERENCE TO RELATED APPLICATION(S)

The present invention claims priority of Korean Patent Application No. 10-2010-0133404, filed on Dec. 23, 2010, which is incorporated herein by reference.

### FIELD OF THE INVENTION

The present invention relates to a technology of environment recognition for operation of a moving object, and more particularly, to an apparatus and method for acquiring stabilized environment recognition data used to operate a moving object in an unstructured environment.

### BACKGROUND OF THE INVENTION

Conventionally, the operation of a moving object, for example, a moving robot is mainly performed in a structured environment. In the structured environment, since environmental structures have a structural and flat bottom, it is easy to establish an environment map and an environmental model and such environment is appropriate for operation of the robot due to its flat bottom. Generally, examples of such environment include a building inside environment such as an office, a shopping mall, and an exhibition center, as well as a relatively structurally composed theme park, or the like.

An unstructured environment is a space in which an irregular form of structures and obstacles are arranged, and has a considerable difficulty in establishing an environment map or an environmental model. In addition, the bottom thereof is uneven and a number of small hills and uneven inclines are present, and thus the operation of a robot is not easy. Examples of such environment include hills and fields, an unpaved road, or the like.

This unstructured environment has problems that it is difficult to establish an environmental model and an environment map for operation of a robot and more fundamentally it is not easy to stably operate environment sensors mounted in the robot, due to a high complexity in the form thereof. The reason is due to an uneven bottom surface. Since the bottom surface is uneven, irregular vibration is generated when the robot is operated. This vibration is transferred to the environment sensors mounted in the robot to cause distortion in sensing signals. Most sensors intended to establish the environment map have the influence described above, and examples thereof may include a camera and a laser finder.

In order to establish a more precise environment map, it is required to stably sense a surrounding environment at the same angle. However, in case where a sensor shakes upward and downward, since a sensed image or laser scanned image may be distorted upward and downward, it is difficult to accurately recognize the structure of an environment, which fails to normally establish an environment map.

### SUMMARY OF THE INVENTION

In view of the above, the present invention provides an environment sensor stabilization apparatus and method for operation of a moving object in an unstructured environment, which are capable of providing conditions that sensing signals sensed by environment sensors mounted in the moving object are stabilized such that the moving object can establish a relatively normal environment map even in a situation in which great shaking occurs during operation of the moving object in the unstructured environment.

In accordance with a first aspect the present invention, there is provided an apparatus for operation of a moving object in an unstructured environment, the apparatus including:

a sensor unit configured to sense vibration of the moving object to produce a sensing signal;

an image capturing unit configured to capture an image of a surrounding environment on which the moving object travels;

a signal synchronization unit configured to synchronize the sensing signal from the sensor unit with the image captured by an image capturing unit through mapping therebetween;

an amplitude extraction unit configured to extract a tilt of the moving object based on the sensing signal from the sensor unit, and calculate a viewing angle and a moving distance of the moving object based on the calculated tilt; and

an image correction unit configured to perform coordinate transformation on the captured image by using the viewing angle and the moving distance to generate a corrected image.

In accordance with a second aspect the present invention, there is provided an apparatus for operation of a moving object in an unstructured environment, the apparatus including:

a sensor unit configured to sense vibration of the moving object to produce a sensing signal;

a three-dimensional (3D) map generation unit configured to generation a 3D depth map;

a signal synchronization unit configured to synchronize the sensing signal with the 3D depth map generated by the 3D map generation unit through mapping therebetween when the sensing signal is output from the sensor unit;

an amplitude extraction unit configured to extract a tilt of the moving object based on the sensing signal from the sensor unit, and calculate a viewing angle and a moving distance of the moving object based on the tilt; and

an image correction unit configured to perform coordinate transformation on the 3D depth map by using the viewing angle and the moving distance to generate a corrected 3D image.

In accordance with a third aspect the present invention, there is provided a method for operation of a moving object in an unstructured environment, the method including:

sensing vibration of the moving object based on a sensing signal obtained from a sensor unit;

when the vibration is sensed, synchronizing the sensing signal when the vibration is sensed, with an image photographed by an image capturing unit through mapping therebetween;

extracting a tilt of the moving object based on the sensing signal from the sensor unit;

calculating a viewing angle and a moving distance of the moving object based on the tilt; and

performing coordinate transformation on the photographed image by using the viewing angle and the moving distance to generate a corrected image.

In accordance with a fourth aspect the present invention, there is provided a method for operation of a moving object in an unstructured environment, the method including:

sensing vibration of the moving object based on a sensing signal obtained from a sensor unit;

synchronizing the sensing signal with a 3D depth map generated by a 3D map generation unit through mapping therebetween when the sensing signal is obtained from the sensor unit;

extracting a tilt of the moving object based on the sensing signal from the sensor unit;

calculating a viewing angle and a moving distance of the moving object based on the tilt; and

performing coordinate transformation on the 3D depth map by using the viewing angle and the moving distance to generate a corrected 3D image.

### BRIEF DESCRIPTION OF THE DRAWINGS

The above and other objects and features of the present invention will become apparent from the following description of embodiments, given in conjunction with the accompanying drawings, in which:

FIG. 1 is a block diagram of an environment sensor stabilization apparatus for operation of a moving object in an unstructured environment in accordance with an embodiment of the present invention;

FIG. 2 explains synchronization between an image signal and a sensing signal in the environment sensor stabilization apparatus in accordance with the embodiment of the present invention;

FIGS. 3A and 3B are views for explaining a roll and a pitch of the moving object; and

FIG. 4 is a flowchart illustrating a process of correcting an image by the environment sensor stabilization apparatus in accordance with the embodiment of the present invention.

### DETAILED DESCRIPTION OF THE EMBODIMENTS

Hereinafter, an embodiment of the present invention will be described in detail with reference to the accompanying drawings.

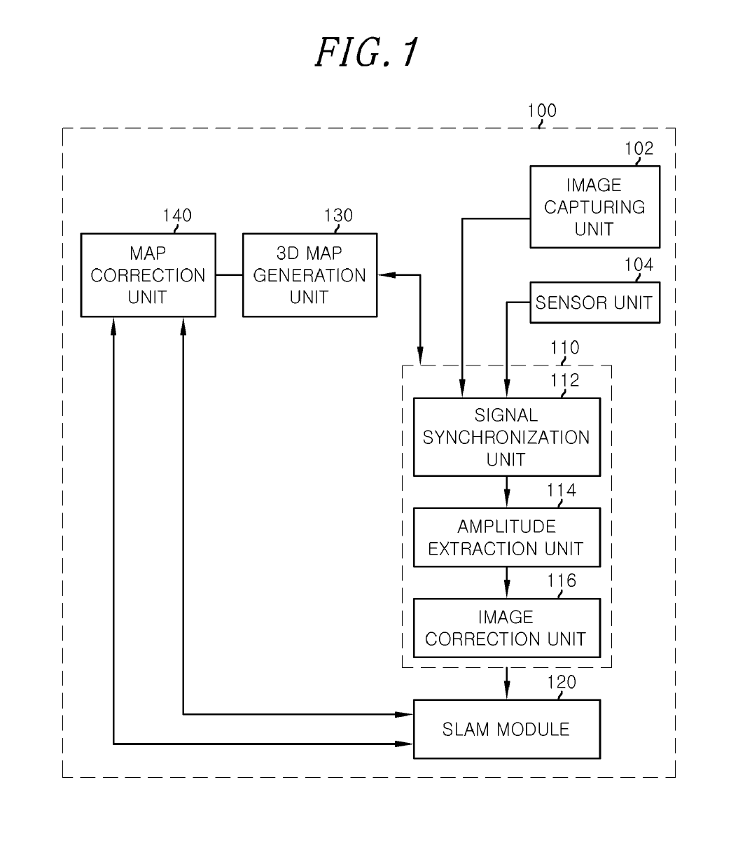

FIG. 1 is a block diagram of an environment sensor stabilization apparatus for operation of a moving object in an unstructured environment in accordance with an embodiment of the present invention. The environment sensor stabilization apparatus includes an image capturing unit 102, a sensor unit 104, a signal stabilization module 110, a simultaneous localization and mapping (SLAM) module 120, a three-dimensional (3D) map generation unit, and a map correction unit 140. The signal stabilization module 110 includes a signal synchronization unit 112, an amplitude extraction unit 114, and an image correction unit 116.

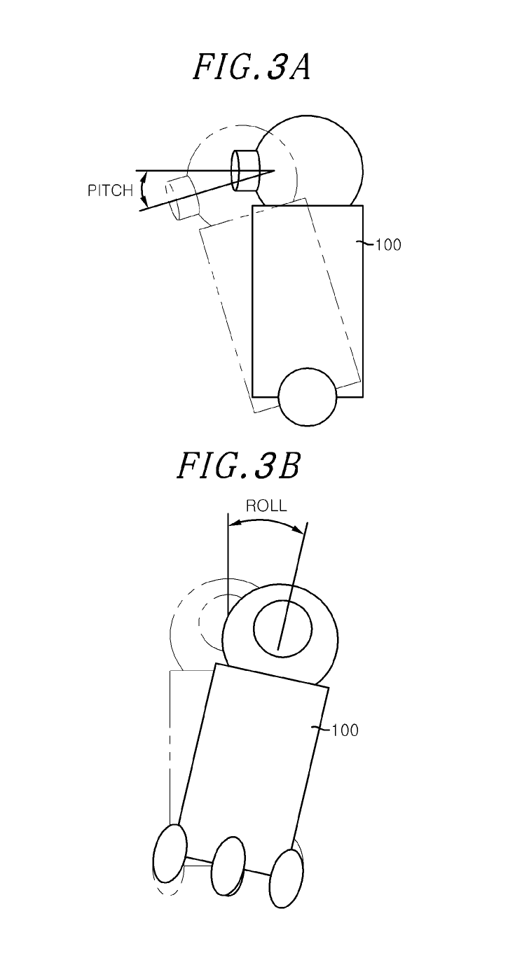

Referring to FIG. 1, all or a portion of the environment sensor stabilization apparatus may be mounted on the moving object which may be a moving robot 100 with wheels shown in FIGS. 3a and 3b, and which freely travels in a structured or unstructured environment.

The image capturing unit 102 may be a camera and serves to capture an image for recognition of an environment in which the robot travels.

The sensor unit 104 senses vibration of the body of the robot 100 and may be, for example, an inertia sensor such as an acceleration sensor, a gyroscope sensor, or the like. The acceleration sensor may output an acceleration signal for sensing vibration applied to the body of the robot 100 to which the sensor unit 104 is fixed. The gyroscope sensor may output a tilt signal for sensing inclination of the body of the robot 100.

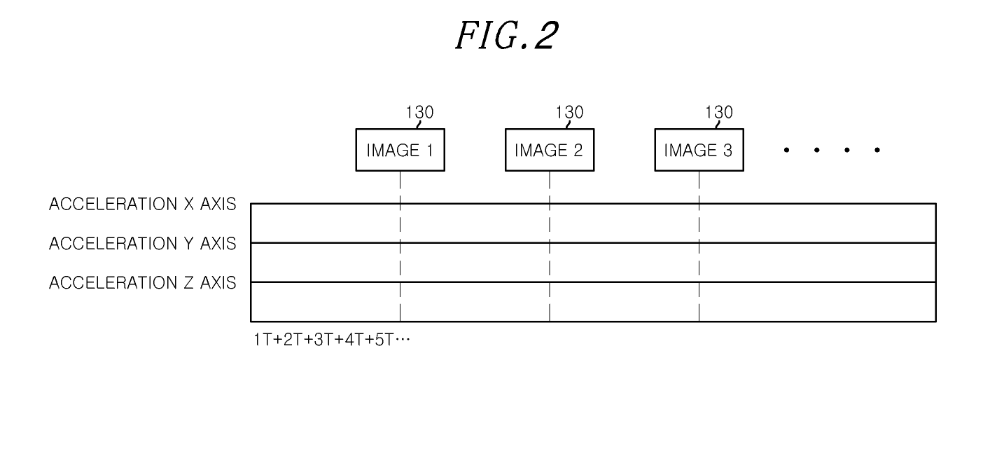

The signal synchronization unit 112 synchronizes the captured image from the image capturing unit 102 and a sensed signal from the sensor unit 104, for example, the acceleration signal, at the same point of time. That is, as shown in FIG. 2, an acceleration signal at a point of time when the body of the robot 100 shakes, and an image captured by the image capturing unit 102 at that point of time can be combined as a pair.

The inertia sensor including an acceleration sensor generally provides a sampling performance of 100 Hz or more, whereas the image capturing unit 102 provides the performance of about 30 fps (feet per second). Thus, images are synchronized with acceleration signals at regular intervals through signal synchronization to thereby generate a resultant product in a form, as shown in FIG. 2.

In accordance with the embodiment of the present invention, by synchronizing images with acceleration signals through the signal synchronization, when an acceleration signal necessary at the time of image correction later is generated (when vibration is generated), a corresponding image can be recognized.

The amplitude extraction unit 114 determines a direction in which the robot 100 is tilted and an extent to which the robot 100 is tilted, by using the sensor unit 104. That is, the amplitude extraction unit 114 extracts a tilted direction of the robot 100 and an extent of the tilt by using the acceleration signal of the sensor unit 104. The tilt generated during traveling of the robot 100 may be a roll and a pitch, and the roll and the pitch may be calculated by using an acceleration signal generated by a 3-axis acceleration sensor. This amplitude extraction unit 114 calculates a roll and a pitch by using an acceleration signal generated from the sensor unit 104 at a point of time at which an image corresponding to the acceleration signal is concurrently captured.

A viewing angle and a moving distance of the image capturing unit 102 can be calculated by using a size of the robot 100 including the calculated roll and pitch, and an installation position and size of the image capturing unit 102 that are stored in advance.

The image correction unit 116 performs coordinate transformation on an actually captured image based on the viewing angle and the moving distance calculated by the amplitude extraction unit 114 such that the actually captured image can be compensated for vibration in the viewing angle due to a shaking of the robot 100 to generate a corrected image.

The corrected image generated by the image correction unit 116 provides through the SLAM module 120.

Meanwhile, the environment sensor stabilization apparatus for operation of a moving object in an unstructured environment further include the 3D map generation unit 130.

The 3D map generation unit 130 generates a 3D depth map of a 3D image and provides the same to the map correction unit 140. The 3D map generation unit 130 may be implemented as, for example, a laser ranger finder. The map correction unit 140 performs a compensation for a movement of the robot 100 in an unstructured environment by using the camera viewing angle and the moving distance calculated by the amplitude extraction unit 104, thereby generating a corrected 3D image. The corrected 3D image is presented through the SLAM module 120.

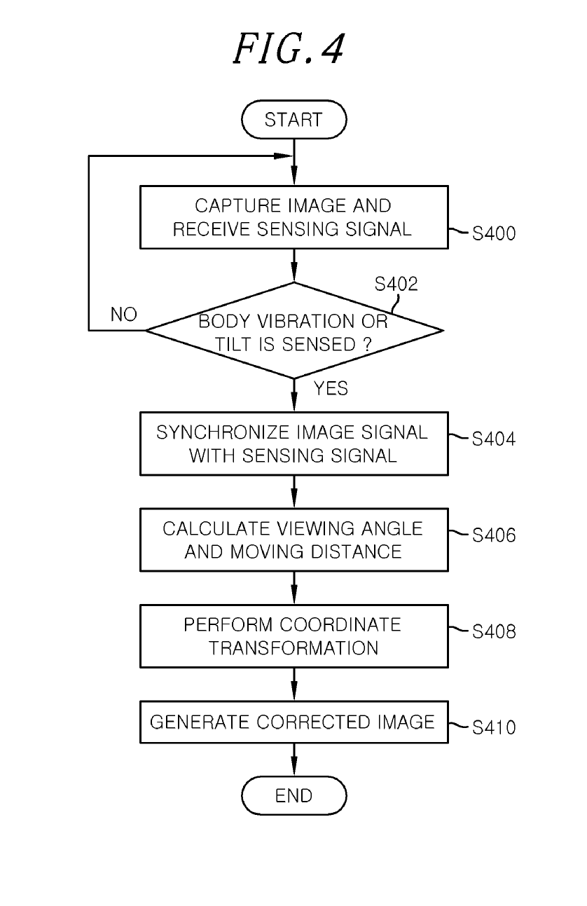

A process performed by the environment sensor stabilization apparatus will be described in detail with reference to FIG. 4.

FIG. 4 is a flowchart illustrating a process of correcting an image by the environment sensor stabilization apparatus in accordance with the embodiment of the present invention.

As shown in FIG. 4, in step S400, as the robot 100 moves, the image capturing unit 102 captures a surrounding environment to generate a captured image signal, and the stabilization module 110 receives the image signal from the image capturing unit 102 and a sensing signal, i.e., an acceleration signal, sensed by the sensor unit 104.

In step S402, the signal stabilization module 110 determines whether or not vibration or tilt of the robot 100 is sensed based on the sensing signal.

When the vibration or the tilt of the robot 100 is sensed as a result of the determination in step S402, the process advances to step S404. In step S404, the signal stabilization module 110 synchronizes the image signal generated by the image capturing unit 102 with the acceleration signal of the sensor unit 104 through the signal synchronization unit 112. In other words, the signal synchronization unit 112 synchronizes the image signal, captured at a point of time at which the acceleration signal is concurrently generated, with the acceleration signal through mapping therebetween.

Next, in step S406, the signal stabilization module 110 measures an inclined direction of the robot 100 and an extent of the tilt by using the acceleration signal. More specifically, the signal stabilization module 110 calculates a roll and a pitch of the robot 100 using the acceleration signal and then calculates a viewing angle and a moving distance of the image capturing unit 102 by using the calculated roll and pitch. In order to calculate the viewing angle and the moving distance of the image capturing unit 102, a size of the robot 100 including an installation position and size of the image capturing unit 102 within the robot 100 may be used.

Thereafter, the image correction unit 116 performs coordinate transformation on the viewing angle and the moving distance calculated by the amplitude extraction unit 114 in step S408, and then corrects the image mapped to the sensing signal by using the transformed coordinates to generate a corrected image in step S410. In this manner, the corrected image, which is compensated for vibration in the viewing angle of the image due to shaking of the robot 100, can be generated through the coordinate transformation.

The embodiment of the present invention illustrates a case in which a corrected image is generated only by the image capturing unit 102 by way of example, but a corrected 3D map may be generated by using the 3D map generation unit 130. In this case, a laser ranger finder, which is the 3D map generation unit 130, may calculate a moving distance and a viewing angle of the 3D map generation unit 130 based on a position and a size installed in the robot 100 and the size of the robot 100.

In addition, the embodiment of the present invention illustrates a case in which a moving distance and a viewing angle of the image capturing unit 102 or the 3D map generation unit 130 are calculated by way of example, but a moving distance of the robot 100 as a moving object, and a viewing angle and a moving distance based on vibration and a shaking thereof may be calculated.

In accordance with the embodiment of the present invention, an inertia sensor such as an acceleration sensor, a gyroscope sensor, or the like may be fixed to the body of the robot 100 such that a shaking such as a roll and a pitch of the body is sensed in real time. Here, the magnitude of change in the viewing angle of the image capturing unit 102 such as a camera, a laser finder, or the like mounted in the robot 100 is calculated, and then an image is corrected by using the calculated magnitude. Thus, even in an environment in which a shaking is great during running, the environment may be recognized and a map may be established stably by using the robot. As a result, the robot may be utilized in the unstructured environment.

While the invention has been shown and described with respect to the particular embodiments, it will be understood by those skilled in the art that various changes and modification may be made without departing from the scope of the present invention as defined in the following claims.

What is claimed is:

1. An apparatus for operation of a moving object in an unstructured environment, the apparatus comprising:
a sensor unit configured to sense vibration of the moving object to produce a sensing signal;
an image capturing unit configured to capture an image of a surrounding environment on which the moving object travels;
a signal synchronization unit configured to synchronize the sensing signal from the sensor unit with the image captured by an image capturing unit through mapping therebetween;
an amplitude extraction unit configured to extract a tilt of the moving object based on the sensing signal from the sensor unit, and calculate a viewing angle and a moving distance of the moving object based on the calculated tilt; and
an image correction unit configured to perform coordinate transformation on the captured image by using the viewing angle and the moving distance to generate a corrected image.

2. The apparatus of claim 1, wherein the sensor unit includes an acceleration sensor or a gyroscope sensor.

3. The apparatus of claim 1, wherein the amplitude extraction unit is configured to calculate a roll and a pitch of the moving object by using the sensing signal mapped to the captured image, and calculate the viewing angle of the moving object and the moving distance in which the moving object has moved by using the roll and the pitch.

4. The apparatus of claim 1, wherein the amplitude extraction unit is configured to calculate the viewing angle of the moving object and a value of the moving distance in which the moving object has moved by using an installation position and a size of the image capturing unit mounted in the moving object, and a size of the moving object.

5. An apparatus for operation of a moving object in an unstructured environment, the apparatus comprising:
a sensor unit configured to sense vibration of the moving object to produce a sensing signal;
a three-dimensional (3D) map generation unit configured to generation a 3D depth map;
a signal synchronization unit configured to synchronize the sensing signal with the 3D depth map generated by the 3D map generation unit through mapping therebetween when the sensing signal is output from the sensor unit;
an amplitude extraction unit configured to extract a tilt of the moving object based on the sensing signal from the sensor unit, and calculate a viewing angle and a moving distance of the moving object based on the tilt; and
an image correction unit configured to perform coordinate transformation on the 3D depth map by using the viewing angle and the moving distance to generate a corrected 3D image.

6. The apparatus of claim 5, wherein the 3D map generation unit includes a laser finder.

7. The apparatus of claim 5, wherein the sensor unit includes an acceleration sensor or a gyroscope sensor.

8. The apparatus of claim 5, wherein the amplitude extraction unit is configured to calculate a roll and a pitch of the moving object by using the sensing signal mapped to the 3D depth map, and calculate the viewing angle of the moving object and the moving distance in which the moving object has moved by using the roll and the pitch.

9. The apparatus of claim 5, wherein the amplitude extraction unit is configured to calculate the viewing angle of the moving object and a value of the moving distance in which the moving object has moved by using an installation position and a size of the 3D map generation unit, and a size of the moving objected.

10. A method for operation of a moving object in an unstructured environment, the method comprising:
sensing vibration of the moving object based on a sensing signal obtained from a sensor unit;
when the vibration is sensed, synchronizing the sensing signal when the vibration is sensed, with an image photographed by an image capturing unit through mapping therebetween;
extracting a tilt of the moving object based on the sensing signal from the sensor unit;
calculating a viewing angle and a moving distance of the moving object based on the tilt; and
performing coordinate transformation on the photographed image by using the viewing angle and the moving distance to generate a corrected image.

11. The method of claim 10, wherein said calculating a viewing angle and a moving distance includes:
calculating a roll and a pitch of the moving object by using the sensing signal mapped to the photographed image; and
calculating the viewing angle of the moving object and the moving distance in which the moving object has moved by using the roll and the pitch.

12. The method of claim 10, wherein said calculating a viewing angle and a moving distance includes:
calculating the viewing angle of the moving object and a value of the moving distance in which the moving object has moved by using an installation position and a size of the image capturing unit, and a size information of the moving object.

13. A method for operation of a moving object in an unstructured environment, the method comprising:
sensing vibration of the moving object based on a sensing signal obtained from a sensor unit;
synchronizing the sensing signal with a 3D depth map generated by a 3D map generation unit through mapping therebetween when the sensing signal is obtained from the sensor unit;
extracting a tilt of the moving object based on the sensing signal from the sensor unit;
calculating a viewing angle and a moving distance of the moving object based on the tilt; and
performing coordinate transformation on the 3D depth map by using the viewing angle and the moving distance to generate a corrected 3D image.

14. The method of claim 13, wherein said calculating a viewing angle and a moving distance of the moving object includes:
calculating a roll and a pitch of the moving object by using the sensing signal mapped to the 3D depth map; and
calculating the viewing angle of the moving object and the moving distance in which the moving object has moved by using the roll and the pitch.

15. The method of claim 13, wherein said calculating a viewing angle and a moving distance of the moving object includes:
calculating the viewing angle of the moving object and a value of the moving distance in which the moving object has moved by using an installation position and a size of the 3D MAP generation unit, and a size of the moving object.
